(19) United States
(12) Patent Application Publication
(10) Pub. No.: US 2012/0252965 A1
(43) Pub. Date: Oct. 4, 2012

(54) Non-metalic belt buckle

(76) Inventor: Phillip R. Coffman, Murphy, TX (US)

(21) Appl. No.: 13/065,930

(22) Filed: Apr. 1, 2011

(51) Int. Cl. A44B 11/25; A44B 1/02; A41C 1/16; C08K 7/14; C08G 69/26; C08L 55/02; C08L 59/04; C08L 79/08; A44B 11/00; G02C 11/00

(52) U.S. Cl. 524/566; 24/572.1; 24/1; 24/188; 450/41; 351/158; 528/335; 524/593; 524/606

(57) ABSTRACT

A buckle made from a non-metallic and non-magnetic polymer having a minimum flexural strength of 120 MPa wherein the buckle comprises a frame, a bar attached to the frame, and a prong pivotally attached to the bar, the frame has first and second terminal ends, the first terminal end has a first aperture that extends through the first terminal end, the first aperture extends in the plane of the frame and parallel to a back side of the frame, the second terminal end has a second aperture that extends through the second terminal end, the second aperture extends in the plane of the frame and parallel to a back side of the frame, the bar further comprises a main shaft with a first threaded end and a second drive end, the first threaded end is threaded only along portion of the length of the main shaft.

This application claims priority based upon previously file U.S. design application Ser. No. 12/372,399, entitled Non-Metallic Buckle filed on Nov. 16, 2010.

### FIELD OF THE INVENTION

The present invention relates to products and methods of producing non-metallic products that are structurally strong and capable of replacing commensurate metallic components in order to easily pass through security measures. More specifically, the present invention relates to non-magnetic belt buckles, eyeglass frames, garment components and the like. Because of their non-metallic composition these products that are able to pass through security measure and still withstand the rigors of use.

### BACKGROUND

The nature of this invention is a combination of both a unique materials set and method of assemble to create an extremely durable, non-magnetic, non-metallic product, such as a belt buckle, that will aid both the wearer and safety inspectors.

For example, it is known that removing one's belt for security in airports, judicial, legislative, sporting events, concerts, public gatherings, etc. is time consuming and slows down the safety inspection process. Eyeglass frames and metallic clothing components also cause delay in the screening procedure, frequently requiring the wearer to be swept with a hand held magnetometer.

The present invention is a method of manufacturing non-metallic, non-magnetic components that are made from an advanced engineering plastic. Not only do these plastics have superb high tensile strength and impact resistance, it may also be reinforced with a filler material such as glass fibers, graphite, ceramics, etc. that further enhance these mechanical properties. Some particular examples, though not inclusive are Ultem filled with glass gibers and PEEK filled with graphite. Other advanced engineering plastics and resins can be envisioned along with other reinforcing materials such as ceramics.

The products can be assembled in several different ways as shown with novel assembly techniques. The first is to use a buckle that has a thread on one end (method I). A bolt serves both as a holder for the belt clip and secures to the buckle. The second assemble method involves the melting of the plastic on the bolt to fasten it to the buckle (method II). Another embodiment involved the use of the plastic composite buckle and bolt in one piece and the use of a metal clip that is placed into the assembly by bending the end. The majority of the mass is non-metallic, enabling the desired properties described above.

### SUMMARY OF THE INVENTION

It is an object of the present invention to provide a set of products and a method for manufacturing the same that produces non-metallic, non-magnetic components that are structurally strong enough to replace commensurate metallic components.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiment is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of a first embodiment of the present invention.

FIG. 2 is an alternate perspective of view of the first embodiment of the present invention.

FIG. 3 is an exploded view of the first embodiment of the present invention including end caps.

FIG. 4 is cutaway view of the present invention including end caps, along line 4.

FIG. 5 is a top view of the first embodiment of the present invention.

FIG. 6 is a bottom view of the first embodiment of the present invention.

FIG. 7 is a side view of the first embodiment of the present invention, with the tongue shown with dashed lines.

FIG. 8 is a perspective view of a second embodiment of the present invention.

FIG. 9 is a perspective view of a third embodiment of the present invention.

FIG. 10 is a perspective view of a fourth embodiment of the present invention.

FIG. 11 shows the replacement parts according to the present invention separated from the non-replacement parts.

FIG. 12 shows an alternate securing structure of the fourth embodiment.

FIG.'s 13, 14 and 15 are enlargements of the alternate securing structure of the fourth embodiment.

FIG. 16 shows yet another alternate securing structure of the fourth embodiment.

FIG. 17 is an enlargement of the yet another alternate securing structure of the fourth embodiment.

FIG. 18 is a perspective view of a fifth embodiment of the present invention.

FIG. 19 is an exploded perspective view of a sixth embodiment of the present invention.

### DESCRIPTION OF PREFERRED EMBODIMENT

With reference to the drawings and in operation, the present invention provides an apparatus and method for security friendly products, such as belt buckles, eyeglass frames, clothing supports and the like.

The present invention is a non-metallic, non-magnetic load bearing personal wear product.

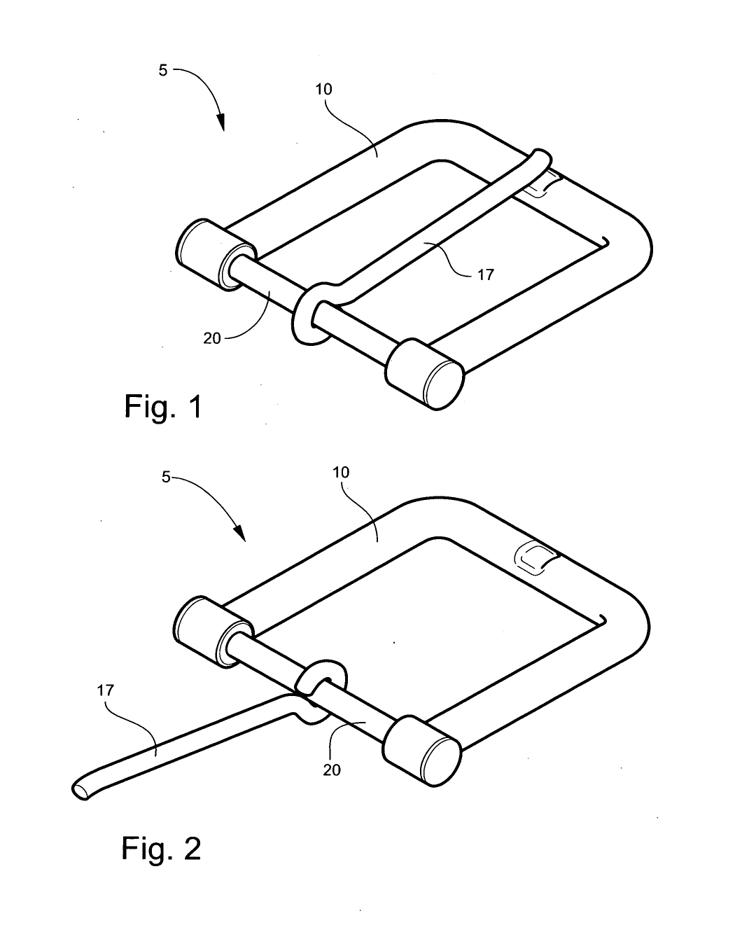

In a first embodiment, shown in FIG. 1, the product is a buckle 5, preferably for belts and the like. The buckle 5 comprises a frame 10, a bar 20 attached to the frame 10, and a prong 17 pivotally attached to the bar 20. FIG. 2 illustrates the pivotability of the prong 17.

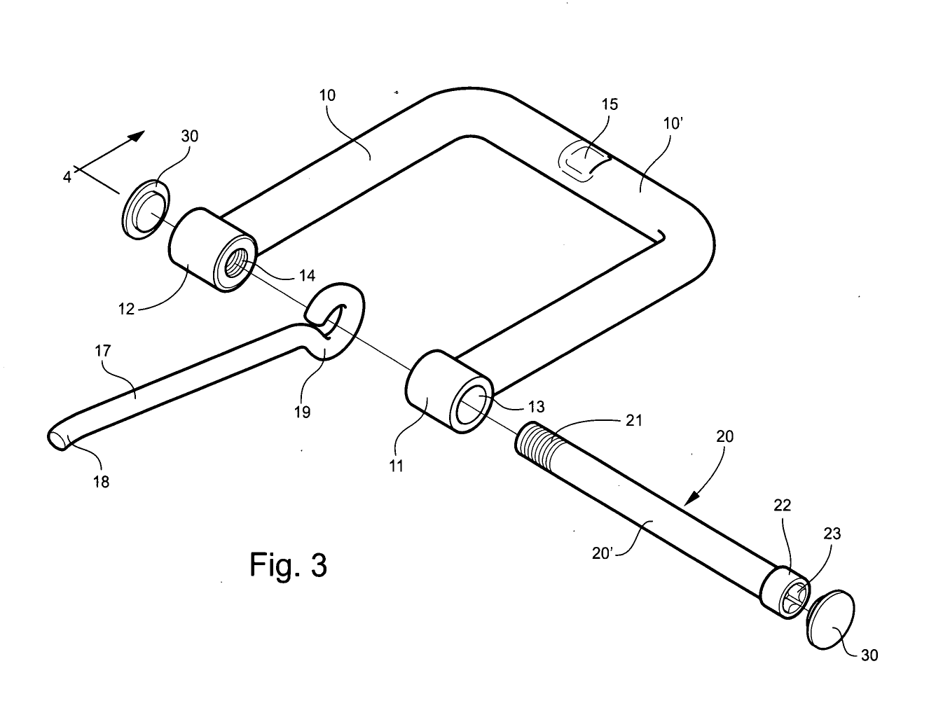

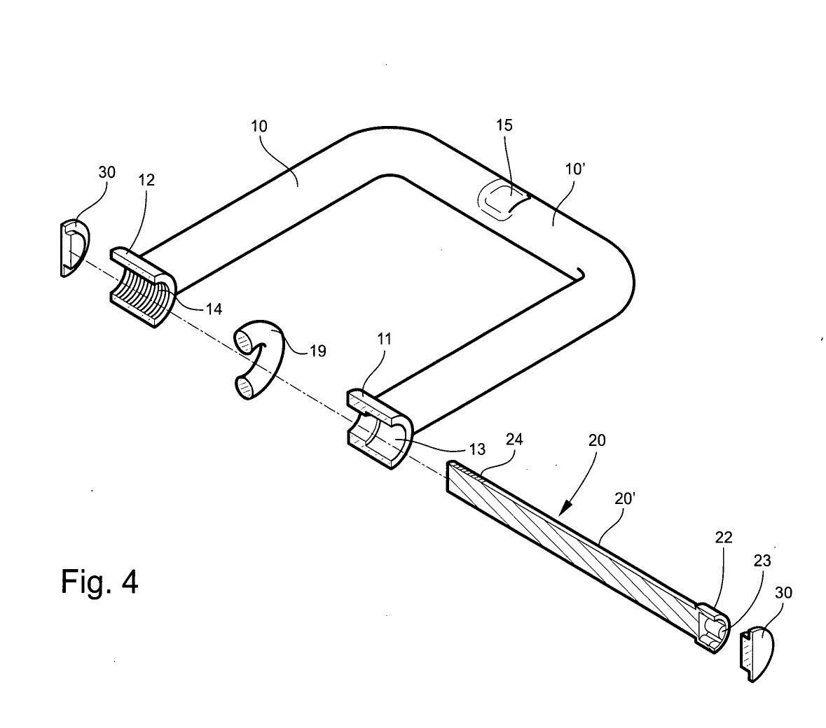

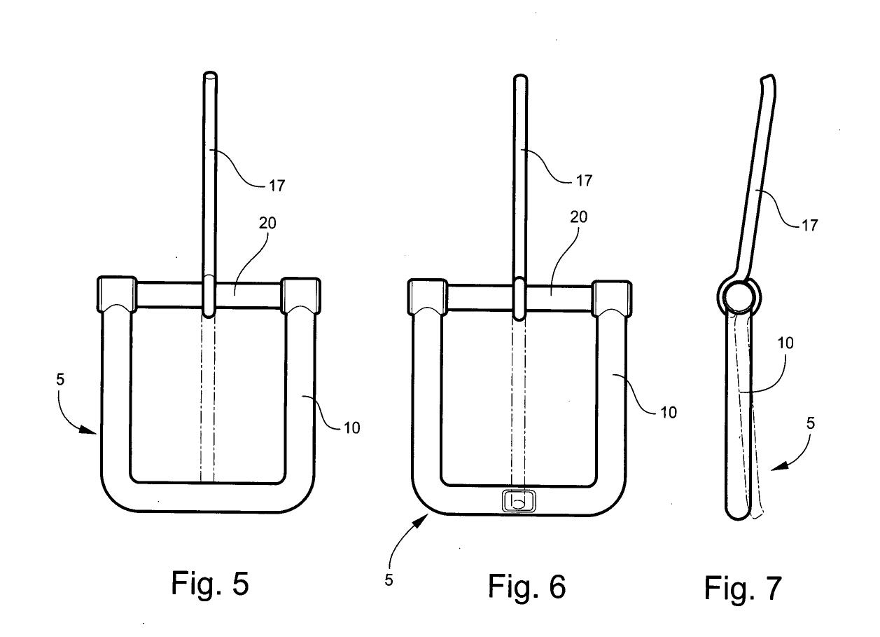

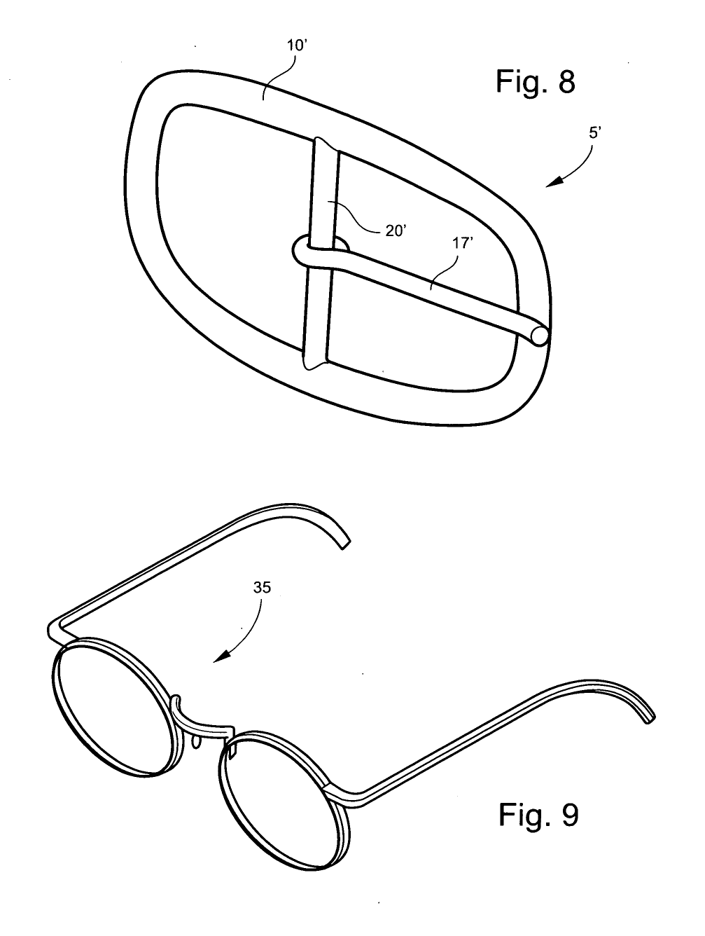

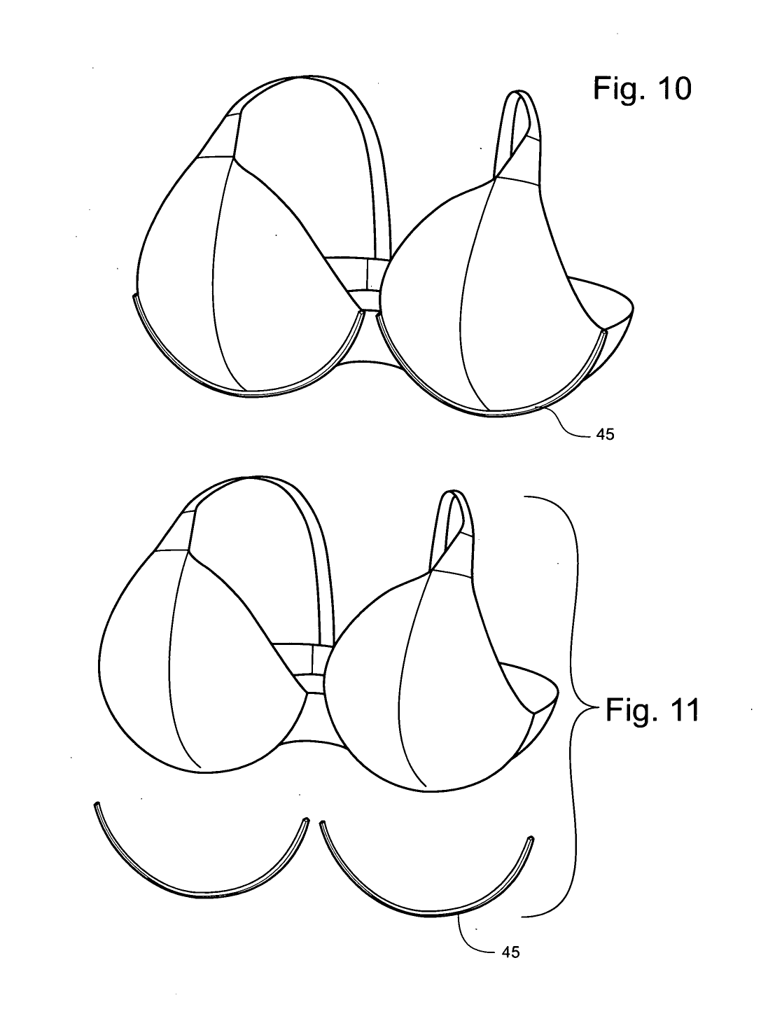

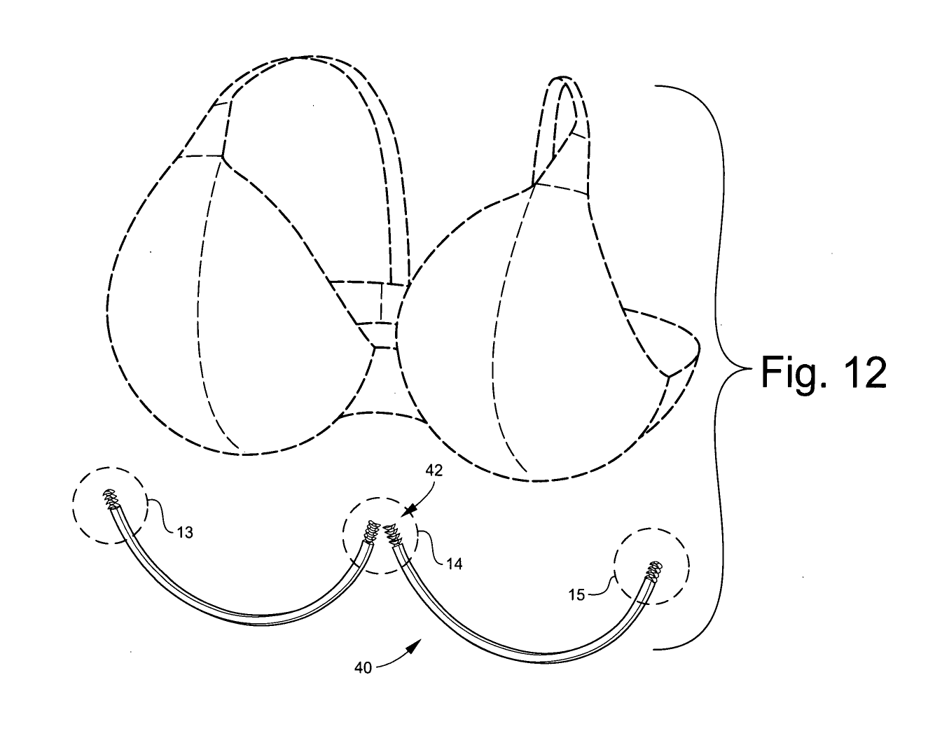

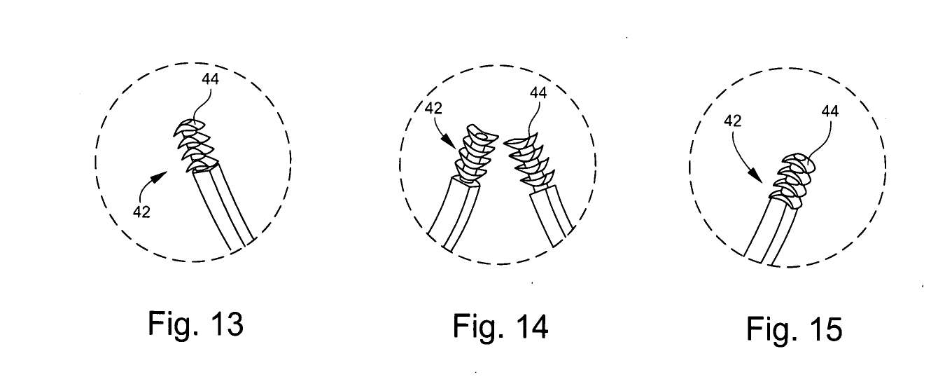

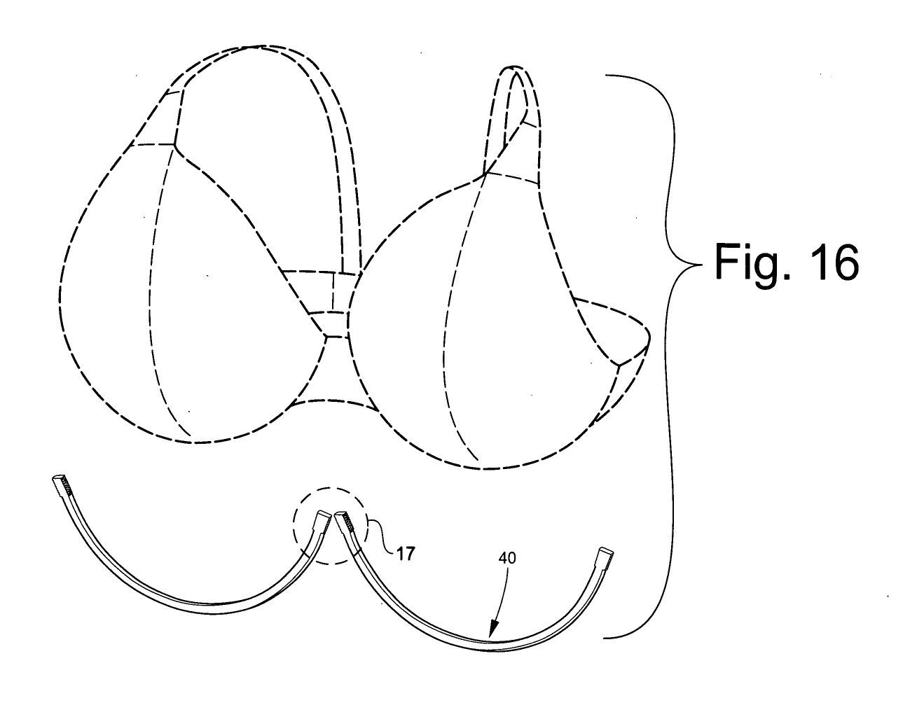

In a preferred embodiment, shown in FIG. 3, in an exploded view, the frame 10 has three substantially straight sides, thereby forming a square shaped C or an open D shape. The frame 10 has first and second terminal ends 11 and 12, respectively. The first terminal end 11 has a first aperture 13 that extends through the first terminal end 11. The first aperture 13 extends in the plane of the frame 10 and parallel to a back side 10′ of the frame. The second terminal end 12 has a second aperture 14 that extends through the second terminal end 12. The second aperture 14 extends in the plane of the frame 10 and parallel to a back side 10′ of the frame. The second aperture 14, preferably, is threaded.

In a preferred embodiment, the back side 10′ of the frame 10 may include a prong end receiving detent 15. The frame 10 can be made from a single piece or it may be made from three separate pieces, attached at appropriate vertices and still fall within the scope of the present invention.

In a preferred embodiment, shown in FIG. 3, in an exploded view, the bar 20, further comprises a main shaft 20′ with a first threaded end 21 and a second drive end 22. The first threaded end 21 is threaded only along portion of the length of the main shaft 20′ and complementarily fits the treading of the second aperture. The second drive end 22, in a preferred embodiment, has a shaped divot 23, the shape of the divot 23 being complementary to a driver, such as an Allen or hex driver or the like.

The prong 17 is substantially straight, with first and second ends 18 and 19, respectively. The first end 18 is a free end and may be bent slightly relative to the rest of the prong 17. The second end 19 is an attachment end that pivotally attaches to the bar 20 of the buckle 5. In a preferred embodiment, the second end 19 is shaped to form an eye having an aperture through which the bar 20 may be inserted.

Finally, the first embodiment may also include at least one, preferably two caps 30, one of which fits into one end of the second aperture 14 and the other fits into the divot 23 of the second drive end 22.

In a second embodiment, the product is also a buckle 5′, however, the buckle 5′ is a “double-loop” or “center post” buckle where the prong 17′ is attached to a bar 20 that extents through a center section of a rectangular or oval frame 10′.

In a third embodiment, the product is an eyeglass frame 30. Most ophthalmic frames are made up from three parts: a front, a left temple, and a right temple (see FIG. 9). The front includes a bridge that connects two lens containers. It also functions to support the glasses on the nose. The front holds the lenses in a precise orientation before the patient's eye according to the prescription. The temple of the frame is the long portion that supports the frame on the ears. It is also known as the earpiece. There are a few pieces of metallic hardware commonly found on the frame: hinges with screws. The hinge pivotally connects the earpieces to the front. The hinge is a frame component consisting of three main parts: the two halves of the hinge barrel and a pivot pin or screw. One barrel half is mounted in the frame front, the other mating barrel half is mounted in the temple piece. The pivot pin or screw secures the two halves of the hinge barrel together. Since these are metallic, they frequently set off metal detectors at security stations.

In the present invention, it is critical that the eyeglass frame 30 omits the metallic portions, using instead the structural strength of the plastics of the present invention for strength and support.

In a fourth embodiment, shown in FIGS. 10 and 11, the device is a support structure 40 for a woman's undergarment (bra). The support structure 40 is commonly know as the “wire” of an under wire bra. When the wire is metallic, it frequently sets off metal detectors at security stations.

In this fourth embodiment, there are unique securing structures 42 that are designed to help secure and maintain the position of the support structure 40. In a preferred embodiment, the securing structures 42 are a series of barb-like projections 44, illustrated in FIG. 13-15. In a most preferred embodiment, the barb-like projections 44 are truncated disks. That is, a disk shape that has two sides removed. In the most preferred embodiment, there are multiple barb-like projections 44 serially located along the end of the securing structures 42.

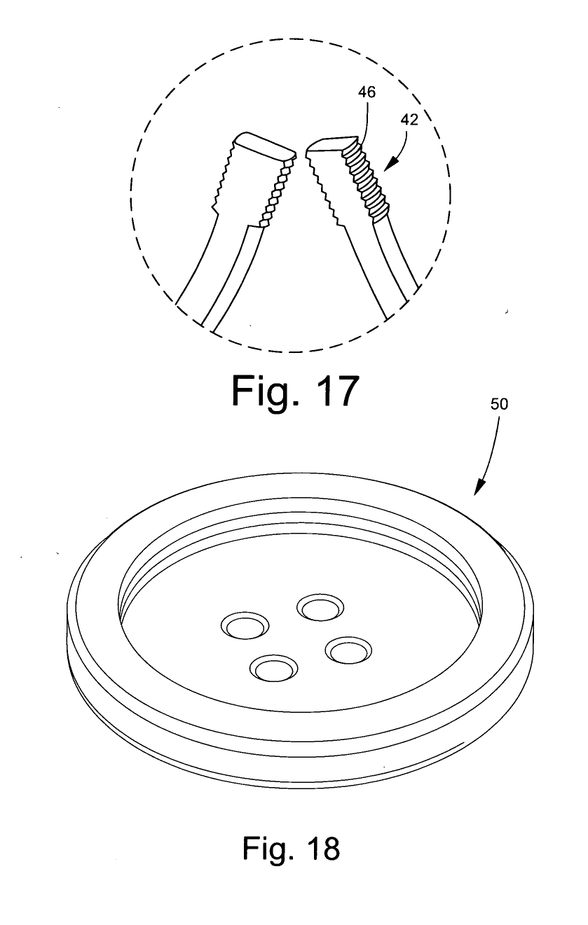

In yet another preferred form of the fourth embodiment, illustrated in FIG. 17, the securing structure 40 are flattened teeth 46, similar to threading of a bolt.

In a fifth embodiment, shown in FIG. 18, the product is a button 50.

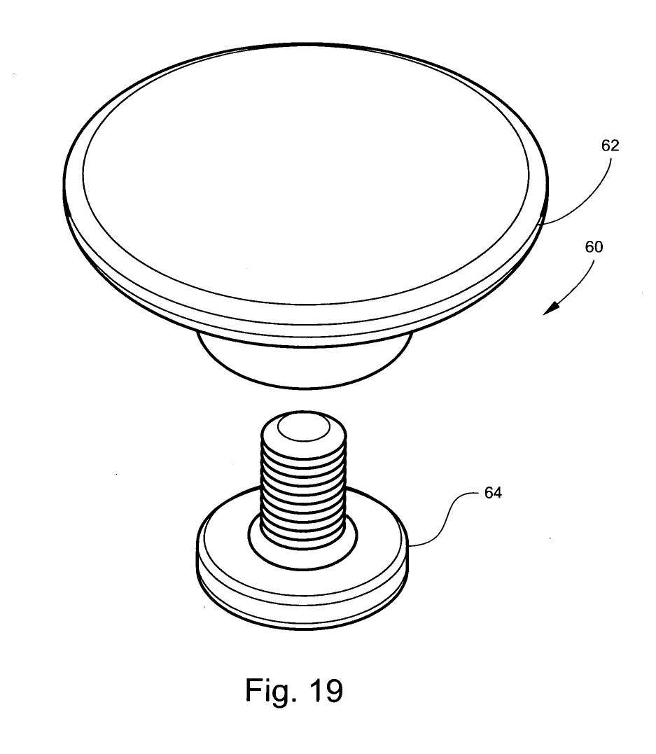

In a sixth embodiment of the present invention, shown in FIG. 19, the product is a two piece button 60, having a top part 62 and a bottom part 64.

Finite Element Analysis (FEA) was performed on the novel designs. In the buckle a simulation, stress distribution with a 15 pound load was applied at pin notch and pivot shaft face held static. These calculations demonstrated that high stress areas are located near the corners. The type of stress discovered in this study and where it is spatially located is similar to a mechanical bending test. This particular test is used to measure flexural strength.

The flexural strength of a material is defined as its ability to resist deformation under load. For materials that deform significantly but do not break, the load at yield, typically measured at 5% deformation/strain of the outer surface, is reported as the flexural strength or flexural yield strength. The test beam is under compressive stress at the concave surface and tensile stress at the convex surface.

The table below shows some flexural strength values for some plastics:

TABLE I
Typical Flexural Strength and Flexural Modulus of Polymers

| | Flexural | Flexural |
|---|---|---|
| Polymer Type | Strength (MPa) | Modulus (GPa) |
| ABS | 75 | 2.5 |
| ABS + 30% Glass (linear) Fiber | 120 | 7 |
| Acetal Copolymer | 85 | 2.5 |
| Acetal Copolymer + 30% Glass Fiber | 150 | 7.5 |
| Acrylic | 100 | 3 |
| Nylon 6 | 85 | 2.3 |
| Polyamide-Imide | 175 | 5 |
| Polycarbonate | 90 | 2.3 |
| Polyethylene, MDPE | 40 | 0.7 |
| Polyethylene Terephthalate (PET) | 80 | 1 |
| Polyimide | 140 | 3 |
| Polyimide + Glass Fiber | 270 | 12 |
| Polypropylene | 40 | 1.5 |
| Polystyrene | 70 | 2.5 |

It has been determined that a minimum flexural strength of 120 MPa is required for this application.

In manufacture, it is preferred that the present invention utilize manufacturing techniques such as compression molding. Compression molding is a method of molding in which the starting material is preheated by placing it in an open, heated mold cavity. The mold is closed with a top force or plug member. Pressure is applied to force the starting material into contact with all mold areas while heat and pressure are maintained until the starting material has cured. Compression molding is a high-volume, high-pressure method suitable for molding complex, high-strength parts. Advanced composite thermoplastics can also be compression molded with unidirectional tapes, woven fabrics, randomly oriented fiber mats or chopped strands included. One advantage of compression molding is its ability to mold large, fairly intricate parts. Other molding techniques may be used, such as transfer molding and injection molding and still fall within the scope of the present invention.

The preferred starting materials for the process of the present invention are thermosetting resins in a partially cured stage, either in the form of granules, putty-like masses, or performs as a starting material, Polyester fiberglass resin systems (SMC/BMC), Torlon, Vespel, Ploy(p-phenylene sulfide) (PPS), and carbon fiber/epoxy materials systems with and without carbon nanotube as a reinforcing agent.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A non-metallic security friendly load bearing structure comprising a personal wear product made from a non-metallic and non-magnetic polymer having a minimum flexural strength of 120 MPa.

2. The product according to claim 1 wherein the personal wear product is a buckle.

3. The product according to claim 1 wherein the personal wear product is an eyeglass frame.

4. The product according to claim 1 wherein the personal wear product is a bra underwire.

5. The product according to claim 1 wherein the personal wear product is a single piece button.

6. The product according to claim 1 wherein the personal wear product is a two piece button.

7. The product according to claim 1 wherein the non-metallic and non-magnetic polymer having a minimum flexural strength of 120 MPa is selected from the group comprising ABS+linear fiber, acetal copolymer+linear fiber, polyamide-imide, polyimide, polyimide+liner fiber.

8. The product according to claim 2 wherein the buckle further comprises a frame, a bar attached to the frame, and a prong pivotally attached to the bar, the frame has three substantially straight sides, thereby forming a square shaped C or an open D shape, the frame as first and second terminal ends and, respectively, the first terminal end has a first aperture that extends through the first terminal end, the first aperture extends in the plane of the frame and parallel to a back side of the frame, the second terminal end has a second aperture that extends through the second terminal end, the second aperture extends in the plane of the frame and parallel to a back side of the frame, the second aperture is threaded, the back side of the frame includes a prong end receiving detent, the bar further comprises a main shaft with a first threaded end and a second drive end, the first threaded end is threaded only along portion of the length of the main shaft and complementarily fits the treading of the second aperture, the second drive end has a shaped divot, the shape of the divot being complementary to a driver.
